(19) United States
(12) Patent Application Publication
(10) Pub. No.: US 2025/0141348 A1
(43) Pub. Date: May 1, 2025

(54) CONTROL METHOD FOR RESONANT CONVERTER AND RESONANT CONVERTER

(71) Applicant: Delta Electronics (Shanghai) CO., LTD., Shanghai (CN)

(72) Inventors: Min XU, Shanghai (CN); Yuhua HU, Shanghai (CN); Hui HUANG, Shanghai (CN); Kai DONG, Shanghai (CN)

(73) Assignee: Delta Electronics (Shanghai) CO., LTD., Shanghai (CN)

(21) Appl. No.: 18/914,332

(22) Filed: Oct. 14, 2024

(30) Foreign Application Priority Data
Oct. 27, 2023 (CN) 2023114148817

(51) Int. Cl. H02M 3/00; H02M 1/38; H02M 3/335

(52) U.S. Cl. CPC H02M 3/01; H02M 1/38; H02M 3/33592; H02M 3/33573

(57) ABSTRACT

The present disclosure provides a control method for a resonant converter and a resonant converter, and relates to the technical field of resonant converters. The resonant converter includes a primary side switch and a corresponding rectification switch, the primary side switch is controlled by a first control signal, the rectification switch is controlled by a second control signal, and the method includes: acquiring a voltage difference value, where the voltage difference value is obtained by subtracting a voltage value of an output voltage of the resonant converter from a reference voltage value; and adjusting a turn-on dead time and/or a turn-off dead time between the first control signal and the second control signal according to the voltage difference value.

### CROSS REFERENCE

This application is based upon and claims priority to Chinese Patent Application No. 2023114148817, filed on Oct. 27, 2023, the entire contents thereof are incorporated herein by reference.

### TECHNICAL FIELD

The present disclosure relates to the technical field of resonant converters, and particularly, to a control method for a resonant converter and a resonant converter.

### BACKGROUND

In the technical field of resonant conversion, with the application of artificial intelligence (AI), the requirements for peak load and electric data peak processing (EDPP) have also emerged, and the slope of the load carried by the resonant converter is also getting higher and higher. In this case, the limited frequency regulation bandwidth of the resonant converter does not provide enough gain suppression, which results in a large overshoot in the voltage output by the resonant converter.

However, the load of the resonant converter has a specified application range in terms of voltage, and when the voltage is relatively high, it will lead to an overvoltage protection of the post-stage converter, which results in the risk of downtime. Therefore, how to avoid excessive voltage rise when an overshoot occurs in the voltage output by the resonant converter is an urgent problem to be solved.

It should be noted that the information disclosed in the above background is only used to enhance an understanding of the background of the present disclosure, therefore it may include information that does not constitute the prior art known to those skilled in the art.

### SUMMARY

The present disclosure provides a control method for a resonant converter and a resonant converter, which at least to a certain extent provide a manner that can prevent the voltage from rising too high when an overshoot occurs in the voltage output by the resonant converter.

According to an aspect of the present disclosure, a control method for a resonant converter is provided. The resonant converter includes a primary side switch and a corresponding rectification switch, the primary side switch is controlled by a first control signal, the rectification switch is controlled by a second control signal, and the method includes: acquiring a voltage difference value, where the voltage difference value is obtained by subtracting a voltage value of an output voltage of the resonant converter from a reference voltage value; and adjusting a turn-on dead time and/or a turn-off dead time between the first control signal and the second control signal according to the voltage difference value.

In an embodiment of the present disclosure, adjusting the turn-on dead time and/or the turn-off dead time between the first control signal and the second control signal according to the voltage difference value, includes: in response to that the voltage difference value is less than a first voltage threshold, adjusting the turn-on dead time and/or the turn-off dead time between the first control signal and the second control signal according to the voltage difference value, where the first voltage threshold is less than or equal to 0V.

In an embodiment of the present disclosure, the method further includes: maintaining a duration of the turn-on dead time and/or the turn-off dead time as a target duration in response to that the voltage difference value is less than a second voltage threshold, where the target duration is a duration of the turn-on dead time and/or the turn-off dead time when the voltage difference value is equal to the second voltage threshold, and the second voltage threshold is less than the first voltage threshold; and in response to that the voltage difference value is less than the second voltage threshold, the rectification switch remains in an off state.

In an embodiment of the present disclosure, the second voltage threshold is determined based on a rated voltage of a load carried by the resonant converter.

In an embodiment of the present disclosure, adjusting the turn-on dead time and/or the turn-off dead time between the first control signal and the second control signal according to the voltage difference value, includes: calculating an opposite number of the voltage difference value; calculating a product of the opposite number and a first coefficient to obtain an expected turn-on dead time; and/or, calculating a product of the opposite number and a second coefficient to obtain an expected turn-off dead time; and modulating the second control signal according to at least one of the expected turn-on dead time and the expected turn-off dead time to adjust the turn-on dead time and/or the turn-off dead time between the first control signal and the second control signal.

In an embodiment of the present disclosure, the method further includes: adjusting a switching frequency of the primary side switch and a switching frequency of the rectification switch according to the voltage difference value, to adjust the output voltage.

According to another aspect of the present disclosure, a resonant converter is provided. The resonant converter includes: a switching circuit including a primary side switch controlled by a first control signal; a resonant tank; a transformer; a synchronous rectification unit including a rectification switch controlled by a second control signal; and a control unit, configured to calculate a voltage difference value obtained by subtracting a voltage value of an output voltage of the resonant converter from a reference voltage value, and adjust a turn-on dead time and/or a turn-off dead time between the first control signal and the second control signal according to the voltage difference value.

In an embodiment of the present disclosure, the control unit includes: a comparison unit, configured to calculate the voltage difference value obtained by subtracting the voltage value of the output voltage of the resonant converter from the reference voltage value; an inversion unit, configured to calculate an opposite number of the voltage difference value in response to that the voltage difference value is less than a first voltage threshold, where the first voltage threshold is less than or equal to 0V; a dead time controller, configured to generate an expected turn-on dead time and/or an expected turn-off dead time corresponding to the opposite number; and a pulse width modulation generator, configured to modulate the second control signal according to the expected turn-on dead time and/or the expected turn-off dead time to adjust the turn-on dead time and/or the turn-off dead time between the first control signal and the second control signal.

In an embodiment of the present disclosure, the control unit is configured to adjust the turn-on dead time and/or the turn-off dead time between the first control signal and the second control signal according to the voltage difference value in response to that the voltage difference value is greater than or equal to a second voltage threshold and less than a first voltage threshold; and the control unit is configured to maintain a duration of the turn-on dead time and/or the turn-off dead time as a target duration in response to that the voltage difference value is less than the second voltage threshold, where the target duration is a duration of the turn-on dead time and/or the turn-off dead time when the voltage difference value is equal to the second voltage threshold, the first voltage threshold is less than or equal to 0V, and the second voltage threshold is less than the first voltage threshold; where in response to that the voltage difference value is equal to the second voltage threshold, the rectification switch remains in an off state.

In an embodiment of the present disclosure, the control unit includes: a comparison unit, configured to calculate the voltage difference value obtained by subtracting the voltage value of the output voltage of the resonant converter from the reference voltage value; an inversion unit, configured to calculate an opposite number of the voltage difference value in response to that the voltage difference value is greater than or equal to the second voltage threshold and less than the first voltage threshold; a dead time controller, configured to generate an expected turn-on dead time and/or an expected turn-off dead time corresponding to the opposite number; a dead time maintainer, configured to maintain the turn-on dead time and/or turn-off dead time as the target duration in response to that the voltage difference value is less than the second voltage threshold; and a pulse width modulation generator, configured to modulate the second control signal according to the expected turn-on dead time and/or the expected turn-off dead time to adjust the turn-on dead time and/or the turn-off dead time between the first control signal and the second control signal.

In an embodiment of the present disclosure, the control unit is further configured to adjust a frequency of the first control signal and a frequency of the second control signal according to the voltage difference value, to adjust a switching frequency of the primary side switch and a switching frequency of the rectification switch.

In an embodiment of the present disclosure, the control unit further includes: a frequency controller, configured to generate an instruction for controlling the frequency of the first control signal and the frequency of the second control signal according to the voltage difference value; and the pulse width modulation generator is further configured to adjust the frequency of the first control signal and the frequency of the second control signal according to the instruction.

In an embodiment of the present disclosure, the second voltage threshold is determined based on a rated voltage of a load carried by the resonant converter.

In an embodiment of the present disclosure, the dead time controller is configured to calculate a product of the opposite number and a first coefficient to obtain the expected turn-on dead time; and/or, calculate a product of the opposite number and a second coefficient to obtain the expected turn-off dead time.

The technical solutions provided by the embodiments of the present disclosure include at least the following beneficial effects.

In the technical solutions provided by the embodiments of the present disclosure, the primary side switch and the rectification switch of the resonant converter are controlled by the first control signal and the second control signal, respectively, and the turn-on dead time and/or the turn-off dead time between the first control signal and the second control signal are adjusted according to the voltage difference value obtained by subtracting the output voltage of the resonant converter from the reference voltage value, so that the gain effect of the resonant converter can be further suppressed by adjusting the turn-on dead time and/or the turn-off dead time when the output voltage of the resonant converter overshoots, thereby preventing the output voltage of the resonant converter from rising too high, and reducing the possibility of overvoltage protection of the post-stage converter, thus reducing the risk of downtime.

Further, the method is simple to implement with low cost requirements, no additional components need to be added to the resonant converter, and the suppression of the gain effect is stable and reliable.

It should be understood that the foregoing general description and the following detailed description are exemplary and explanatory only, and do not limit the present disclosure.

### BRIEF DESCRIPTION OF THE DRAWINGS

The accompanying drawings herein, which are incorporated in and constitute a part of this specification, illustrate embodiments consistent with the present disclosure and are used in conjunction with the specification to explain the principles of the present disclosure. Obviously, the drawings in the following description are only some embodiments of the present disclosure. For those of ordinary skill in the art, other drawings can also be obtained from these drawings without paying creative effort.

FIG. 1 is a schematic diagram of a resonant converter in an embodiment of the present disclosure;

FIG. 2 is a schematic diagram of a turn-on dead time and a turn-off dead time in an embodiment of the present disclosure;

FIG. 3 is a schematic diagram of an LLC resonant converter in an embodiment of the present disclosure;

FIG. 4 is a schematic diagram of a control unit in an embodiment of the present disclosure;

FIG. 5 is a schematic diagram of the control unit in another embodiment of the present disclosure;

FIG. 6 is a schematic diagram of the control unit in a further embodiment of the present disclosure;

FIG. 7 is a schematic diagram of the control unit in yet another embodiment of the present disclosure;

FIG. 8 is a flowchart of a control method for a resonant converter in an embodiment of the present disclosure;

FIG. 9 is a schematic diagram of a simulation result when a dead-zone loop is not configured in an embodiment of the present disclosure;

FIG. 10 is a schematic diagram of a simulation result when the dead-zone loop is configured in an embodiment of the present disclosure;

FIG. 11 is a schematic diagram of simulation results before and after configuring the dead-zone loop in another embodiment of the present disclosure.

### DETAILED DESCRIPTION

Exemplary embodiments will now be described more fully with reference to the accompanying drawings. However, exemplary embodiments can be embodied in various forms and should not be construed as limited to the embodiments set forth herein. On the contrary, these embodiments are provided so that the present disclosure will be more thorough and complete, and will fully convey the concepts of exemplary embodiments to those skilled in the art. In the drawings, the same reference sign indicates the same or similar structure, and repeated descriptions thereof will be omitted. In addition, the drawings are only schematic illustrations of the present disclosure and are not necessarily drawn to scale.

Although relative terms, such as “on” and “under” are used in this specification to describe the relative relationship of one component to another identified in the figure, these terms are used in this specification only for convenience, e.g., in accordance with the exemplary orientations described in the accompanying drawings. It will be understood that, if the apparatus identified in the drawing is turned upside down, the component described as being “on” will become the component described as being “under”. When a structure is “on” another structure, it may mean that the structure is integrally formed on the other structure, or that the structure is “directly” placed on the other structure, or that the structure is “indirectly” placed on the other structure through another structure.

The terms “one”, “a/an”, “the”, “said” and “at least one” are used to indicate the presence of one or more elements/components/etc.; the terms “including/comprising” and “having” are used in an open-ended inclusive sense to mean that there may be additional elements/components/etc. in addition to the listed elements/components/etc.; and the terms “first”, “second” and “third” etc. are used merely as markers and not as quantitative limitations to their objects.

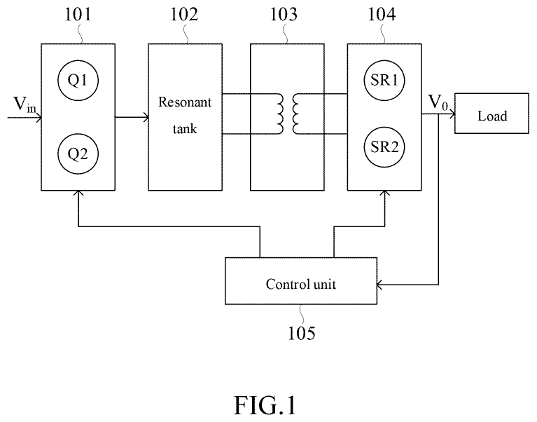

An implementation manner of the present disclosure provides a resonant converter. As shown in FIG. 1, the resonant converter may include: a switching circuit 101, a resonant tank 102, a transformer 103, a synchronous rectification unit 104 and a control unit 105.

The switching circuit 101 includes a primary side switch controlled by a first control signal, and the synchronous rectification unit 104 includes a rectification switch controlled by a second control signal.

In FIG. 1, Vᵢₙ is an input voltage of the resonant converter and is also the voltage of a pre-stage bus. V₀ is an output voltage of the resonant converter. The primary side switch includes two switches, i.e., a first primary side switch Q1 and a second primary side switch Q2. The resonant tank 102 is coupled to the switching circuit 101 and a primary side of the transformer 103, and the switching of the first primary side switch Q1 and the second primary side switch Q2 may cause the resonant tank 102 to resonate. The resonant tank 102 may include a resonant circuit consisting of a capacitor(s) and an inductor(s). The synchronous rectification unit 104 is coupled between a secondary side of the transformer 103 and a load, and the rectification switch may include a first synchronous rectification switch SR1 and a second synchronous rectification switch SR2. The first synchronous rectification switch SR1 has the same conduction time sequence as the first primary side switch Q1 in the switching circuit 101, and the second synchronous rectification switch SR2 has the same conduction time sequence as the second primary side switch Q2.

The first control signal and the second control signal are generated by the control unit 105, and the control unit 105 may also calculate a voltage difference value obtained by subtracting a voltage value of the output voltage of the resonant converter from a reference voltage value, and adjust a turn-on dead time and/or a turn-off dead time between the first control signal and the second control signal according to the voltage difference value.

The turn-on dead time is the time that the conduction of the synchronous rectification switch lags behind the conduction of the primary side switch with the same conduction time sequence within one conduction period. The turn-off dead time is the time that the turn-off of the synchronous rectification switch is ahead of the turn-off of the primary side switch with the same conduction time sequence within one conduction period.

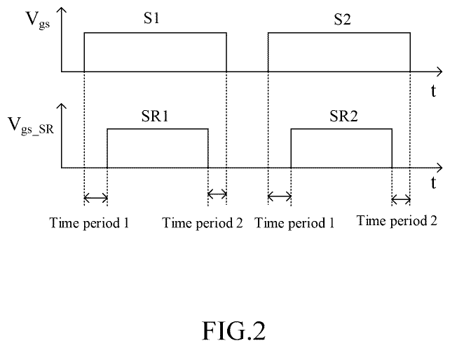

The turn-on dead time and the turn-off dead time may be shown in FIG. 2, where V_{gs} is a voltage of the primary side switch, V_{gs_SR} is a voltage of the synchronous rectification switch, S1 corresponds to the first primary side switch, S2 corresponds to the second primary side switch, SR1 corresponds to the first synchronous rectification switch, SR2 corresponds to the second synchronous rectification switch, and the time indicated by the time period 1 is the turn-on dead time, and the time indicated by the time period 2 is the turn-off dead time.

It should be noted that the turn-on dead time and the turn-off dead time may be the same or different, the turn-on dead time may be greater than the turn-off dead time, or the turn-on dead time may be less than the turn-off dead time, which is not limited by the embodiments of the present disclosure and may be determined according to the specific configuration.

The embodiments of the present disclosure do not limit exactly what kind of resonant converter the resonant converter is. In one embodiment, the resonant converter of the present disclosure may be an LLC resonant converter or any other kind of resonant converter.

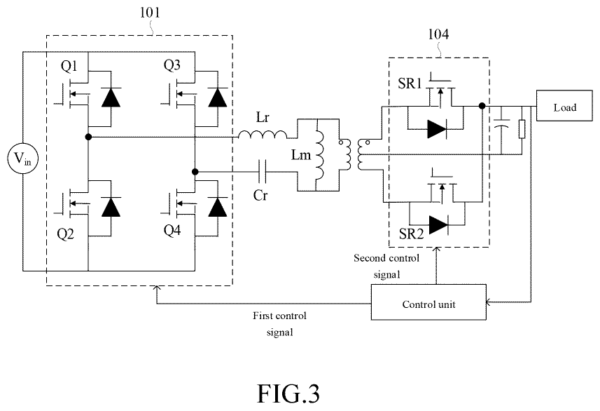

For example, an LLC resonant converter may be shown in FIG. 3. It should be noted that the structure of the LLC resonant converter illustrated in FIG. 3 is merely exemplary, and LLC resonant converters with other structures may also be applied here.

In the technical solutions provided by the embodiments of the present disclosure, the primary side switch and the rectification switch of the resonant converter are controlled by the first control signal and the second control signal, respectively, and the turn-on dead time and/or the turn-off dead time between the first control signal and the second control signal are adjusted according to the voltage difference value obtained by subtracting the output voltage of the resonant converter from the reference voltage value, so that the gain of the resonant converter can be further suppressed by adjusting the turn-on dead time and/or the turn-off dead time when the output voltage of the resonant converter overshoots, thereby preventing the output voltage of the resonant converter from rising too high, and reducing the possibility of overvoltage protection of the post-stage converter, thus reducing the risk of downtime.

Further, the method is simple to implement with low cost requirements, no additional components need to be added to the resonant converter, and the suppression of the gain effect is stable and reliable.

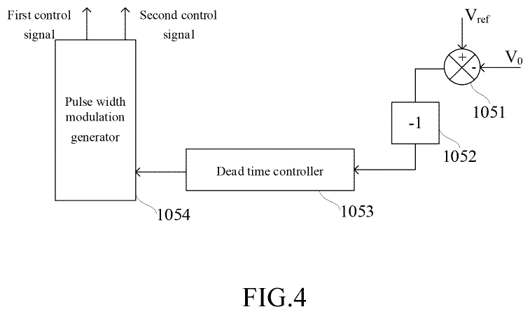

In an embodiment, the control unit 105 may, as shown in FIG. 4, include: a comparison unit 1051, configured to calculate the voltage difference value obtained by subtracting the voltage value of the output voltage of the resonant converter from the reference voltage value; an inversion unit 1052, configured to calculate an opposite number of the voltage difference value in the case that the voltage difference value is less than a first voltage threshold, where the first voltage threshold is less than or equal to 0; a dead time controller 1053, configured to generate an expected turn-on dead time and/or an expected turn-off dead time corresponding to the opposite number; and a pulse width modulation generator (PWM Generator) 1054, configured to modulate the second control signal according to the expected turn-on dead time and/or the expected turn-off dead time, to adjust the turn-on dead time and/or the turn-off dead time between the first control signal and the second control signal.

In FIG. 4, V_{ref} is the reference voltage. The embodiments of the present disclosure do not limit the specific value of the reference voltage. In one embodiment, the reference voltage may be determined based on the rated voltage of the load. For example, the reference voltage is an optimal input voltage specified by the load.

The specific value of the first voltage threshold is not limited in the embodiments of the present disclosure and may be set according to requirements. For example, the first voltage threshold is 0V (volt). For another example, the first voltage threshold is −0.1V. For another example, the first voltage threshold is −1V. For another example, the first voltage threshold is −2V, and so on.

In one embodiment, the first voltage threshold may be determined based on the rated voltage of the load. For example, the first voltage threshold is 0.1 times, or 0.05 times, or other multiples greater than or equal to 0 and less than 1, the value obtained by subtracting the maximum value of the rated voltage of the load from the reference voltage. It should be noted that the value obtained by subtracting the maximum rated voltage of the load from the reference voltage is a negative value.

In some embodiments, when the output voltage of the resonant converter overshoots, the voltage difference value obtained by subtracting the voltage value of the output voltage of the resonant converter from the reference voltage value is a negative value. Therefore, when the voltage difference value is less than the first voltage threshold, it may be considered that an overshoot occurs in the output voltage of the resonant converter, and the turn-on dead time and/or the turn-off dead time need to be adjusted to further suppress a voltage gain of the resonant converter, thereby avoiding damage to the load due to an excessively high voltage rise.

It should be noted that the method of adjusting the turn-on dead time and/or the turn-off dead time between the first control signal and the second control signal by modulating the second control signal utilizes a diode connected in parallel with the synchronous rectification switch to achieve voltage reduction after the synchronous rectification switch is turned off, which is a manner to depress the voltage gain based on a soft-switching.

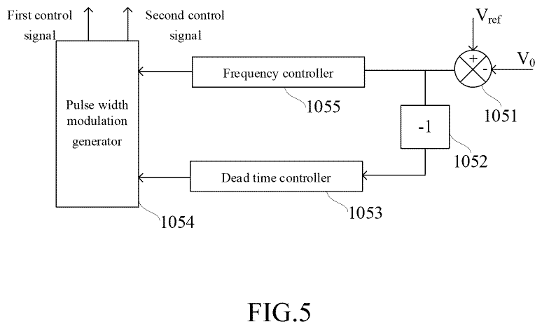

In another embodiment, as shown in FIG. 5, based on the control unit 105 shown in FIG. 4, the control unit 105 may further include a frequency controller 1055. The frequency controller 1055 is configured to generate an instruction for controlling the frequency of the first control signal and the frequency of the second control signal according to the voltage difference value; and the pulse width modulation generator 1054 is further configured to adjust the frequency of the first control signal and the frequency of the second control signal according to the instruction, thereby increasing or suppressing the voltage gain of the resonant converter to keep the output voltage of the resonant converter stable.

In another embodiment of the present disclosure, the control unit 105 is configured to adjust the turn-on dead time and/or the turn-off dead time between the first control signal and the second control signal according to the voltage difference value in the case that the voltage difference value is greater than or equal to a second voltage threshold and less than a first voltage threshold, where the first voltage threshold is less than or equal to 0V, and the second voltage threshold is less than the first voltage threshold; and maintain a duration of the turn-on dead time and/or the turn-off dead time as a target duration in the case that the voltage difference value is less than the second voltage threshold, where the target duration is a duration of the turn-on dead time and/or the turn-off dead time when the voltage difference value is equal to the second voltage threshold.

In the case that the voltage difference value is equal to the second voltage threshold, the rectification switch remains in the off state. That is, as the voltage difference value increases (increases in the negative direction), the turn-on dead time and/or the turn-off dead time between the first control signal and the second control signal increases accordingly, and the rectification switch controlled by the second control signal remains in an off state (i.e., the rectification switch is not turned on during each conduction period) when the voltage difference value is equal to the second voltage threshold. And in the case where the voltage difference value continues to increase, the duration of the turn-on dead time and/or the turn-off dead time is maintained at the target duration, thereby continuing to maintain the maximum gain suppression.

The embodiments of the present disclosure do not limit the specific value of the second voltage threshold. In one embodiment, the second voltage threshold is determined based on the rated voltage of the load carried by the resonant converter. For example, the second voltage threshold is 0.5 times, or 0.6 times, or 0.7 times, or 0.8times, or 0.9 times, or other multiples greater than 0 and less than 1 times the value obtained by subtracting the maximum value of the rated voltage of the load from the reference voltage.

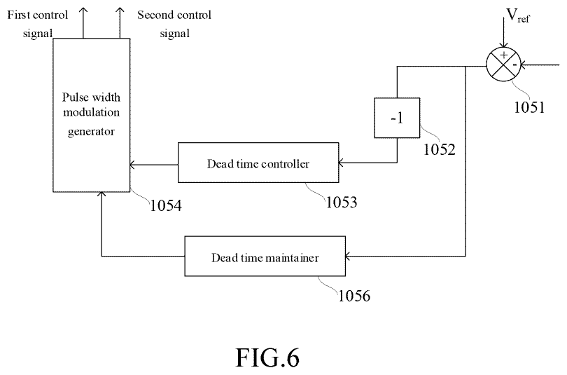

In one embodiment, the control unit 105 may, as shown in FIG. 6, include: a comparison unit 1051, configured to calculate the voltage difference value obtained by subtracting the voltage value of the output voltage of the resonant converter from the reference voltage value; an inversion unit 1052, configured to calculate an opposite number of the voltage difference value in the case that the voltage difference value is greater than or equal to the second voltage threshold and less than the first voltage threshold; a dead time controller 1053, configured to generate an expected turn-on dead time and/or an expected turn-off dead time corresponding to the opposite number; a dead time maintainer 1056, configured to maintain the turn-on dead time and/or turn-off dead time as the target duration in the case that the voltage difference value is less than the second voltage threshold; and a pulse width modulation generator 1054, configured to modulate the second control signal according to the expected turn-on dead time and/or the expected turn-off dead time, to adjust the turn-on dead time and/or the turn-off dead time between the first control signal and the second control signal.

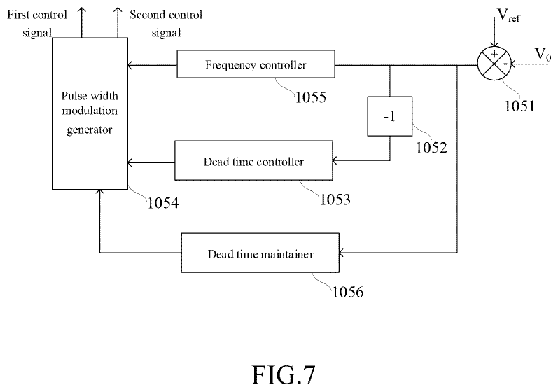

In another embodiment, as shown in FIG. 7, based on the control unit 105 shown in FIG. 6, the control unit 105 may further include a frequency controller 1055.

In an embodiment, the dead time controller is configured to calculate a product of the opposite number and a first coefficient to obtain the expected turn-on dead time; and/or, calculate a product of the opposite number and a second coefficient to obtain the expected turn-off dead time.

The first coefficient and the second coefficient may be the same or different. The first coefficient may be greater than the second coefficient, or may be less than the second coefficient, which is not limited by the embodiments of the present disclosure.

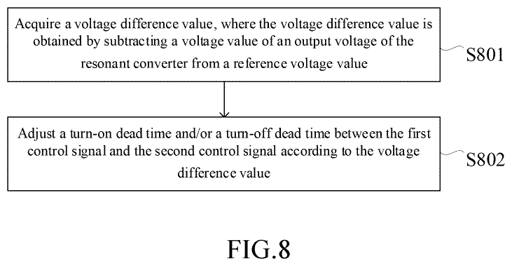

An implementation of the present disclosure further provides a control method for a resonant converter, where the resonant converter includes a primary side switch and a corresponding rectification switch, the primary side switch is controlled by a first control signal, the rectification switch is controlled by a second control signal. As shown in FIG. 8, the control method for the resonant converter may include the following steps S801 to S802. For the specific implementation of steps S801 to S802, reference may be made to the corresponding embodiments of the resonant converter described above.

In step S801, a voltage difference value is acquired, where the voltage difference value is obtained by subtracting a voltage value of an output voltage of the resonant converter from a reference voltage value.

In step S802, a turn-on dead time and/or a turn-off dead time between the first control signal and the second control signal is adjusted according to the voltage difference value.

In the technical solutions provided by the embodiments of the present disclosure, the primary side switch and the rectification switch of the resonant converter are controlled by the first control signal and the second control signal, respectively, and the turn-on dead time and/or the turn-off dead time between the first control signal and the second control signal are adjusted according to the voltage difference value obtained by subtracting the output voltage of the resonant converter from the reference voltage value, so that the gain effect of the resonant converter can be further suppressed by adjusting the turn-on dead time and/or the turn-off dead time when the output voltage of the resonant converter overshoots, thereby preventing the output voltage of the resonant converter from rising too high, and reducing the possibility of overvoltage protection of the post-stage converter, thus reducing the risk of downtime.

Further, the method is simple to implement with low cost requirements, no additional components need to be added to the resonant converter, and the suppression of the gain effect is stable and reliable.

In an embodiment, adjusting the turn-on dead time and/or the turn-off dead time between the first control signal and the second control signal according to the voltage difference value may include: in the case that the voltage difference value is less than a first voltage threshold, adjusting the turn-on dead time and/or the turn-off dead time between the first control signal and the second control signal according to the voltage difference value, where the first voltage threshold is less than or equal to 0V.

In an embodiment, the method may further include: maintaining a duration of the turn-on dead time and/or the turn-off dead time as a target duration in the case that the voltage difference value is less than a second voltage threshold, where the target duration is a duration of the turn-on dead time and/or the turn-off dead time when the voltage difference value is equal to the second voltage threshold, and the second voltage threshold is less than the first voltage threshold; and in the case that the voltage difference value is less than the second voltage threshold, the rectification switch remains in an off state.

In an embodiment, the second voltage threshold is determined based on a rated voltage of a load carried by the resonant converter.

In an embodiment, adjusting the turn-on dead time and/or the turn-off dead time between the first control signal and the second control signal according to the voltage difference value may include: calculating an opposite number of the voltage difference value; calculating a product of the opposite number and a first coefficient to obtain an expected turn-on dead time; and/or, calculating a product of the opposite number and a second coefficient to obtain an expected turn-off dead time; and modulating the second control signal according to at least one of the expected turn-on dead time and the expected turn-off dead time to adjust the turn-on dead time and/or the turn-off dead time between the first control signal and the second control signal.

In an embodiment, a switching frequency of the primary side switch and a switching frequency of the rectification switch may further be adjusted according to the voltage difference value to adjust the output voltage.

In an embodiment, the peak value of overshoot is also affected by a power factor correction (PFC) circuit. When switching from a heavy load to a light load, since the integral of the voltage loop still exists, the bus voltage is charged to a very high level, that is, the input voltage of the resonant converter is charged to a very high level. In this case, the bulk voltage can be prevented from rushing up by using manual de-integral.

The following will take two sets of simulation experiments as examples to illustrate the effects of the technical solutions provided by the embodiments of the present disclosure.

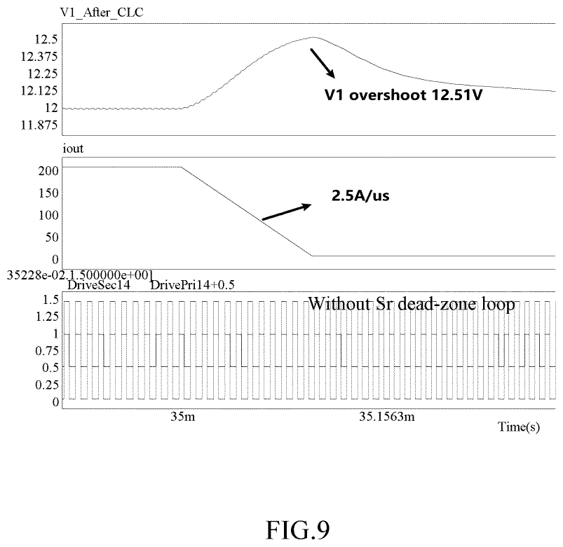

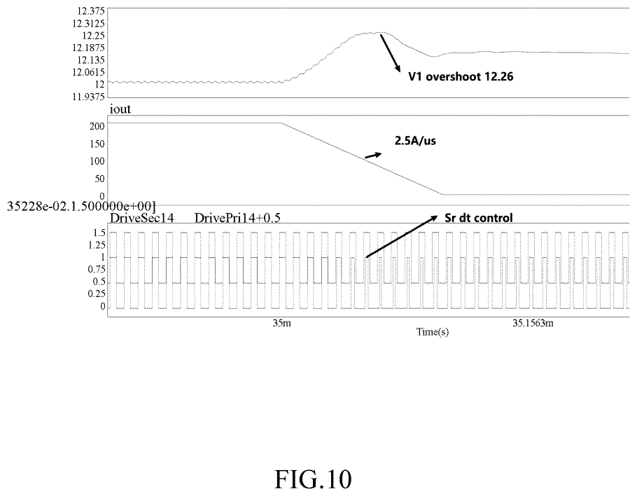

In the first simulation, as shown in FIG. 9, in a case that a dead-zone loop is not provided (as shown in FIG. 4, consisting of the inversion unit 1052 and the dead time controller 1053) and the slope of the load is 2.5 A/microsecond, the peak voltage of the overshoot generated is 12.51V (volts). As shown in FIG. 10, in a case that the dead-zone loop is provided and the slope of the load is 2.5 A/microsecond, the peak voltage of the overshoot generated is 12.26V.

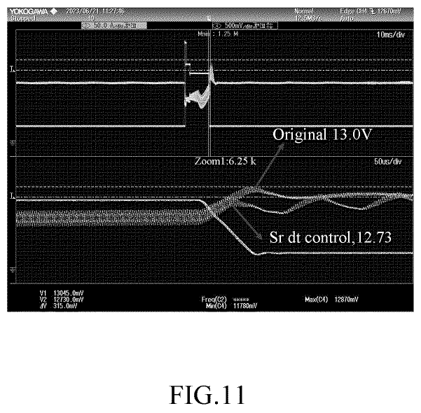

In the second simulation, as shown in FIG. 11, in a case that a dead-zone loop is not provided, the peak voltage of the overshoot generated is 13V. In a case that the dead-zone loop is provided and other conditions are exactly the same, the peak voltage of the overshoot generated is 12.73V.

Other implementation solutions of the present disclosure will be readily apparent to those skilled in the art upon consideration of the specification and practice of the disclosure disclosed herein. The present application is intended to cover any variations, uses, or adaptations of the present disclosure that follow the general principles of the present disclosure and include common knowledge or customary technical means in the technical field that are not disclosed in the present disclosure. The specification and embodiments are to be considered as exemplary only, and the true scope of the present disclosure is indicated by the appended claims.

What is claimed is:

1. A control method for a resonant converter, wherein the resonant converter comprises a primary side switch and a corresponding rectification switch, the primary side switch is controlled by a first control signal, the rectification switch is controlled by a second control signal, and the method comprises:
acquiring a voltage difference value, wherein the voltage difference value is obtained by subtracting a voltage value of an output voltage of the resonant converter from a reference voltage value; and
adjusting at least one of a turn-on dead time or a turn-off dead time between the first control signal and the second control signal according to the voltage difference value.

2. The method according to claim 1, wherein adjusting at least one of the turn-on dead time or the turn-off dead time between the first control signal and the second control signal according to the voltage difference value, comprises:
in response to that the voltage difference value is less than a first voltage threshold, adjusting at least one of the turn-on dead time or the turn-off dead time between the first control signal and the second control signal according to the voltage difference value, wherein the first voltage threshold is less than or equal to 0V.

3. The method according to claim 2, wherein the at least one of the turn-on dead time or the turn-off dead time between the first control signal and the second control signal is adjusted to be increased with an increase in an opposite number of the voltage difference value.

4. The method according to claim 2, further comprising:
maintaining a duration of at least one of the turn-on dead time or the turn-off dead time as a target duration in response to that the voltage difference value is less than a second voltage threshold, wherein the target duration is a duration of at least one of the turn-on dead time or the turn-off dead time when the voltage difference value is equal to the second voltage threshold, and the second voltage threshold is less than the first voltage threshold; and
wherein in response to that the voltage difference value is less than the second voltage threshold, the rectification switch remains in an off state.

5. The method according to claim 3, wherein the second voltage threshold is determined based on a rated voltage of a load carried by the resonant converter.

6. The method according to claim 1, wherein adjusting at least one of the turn-on dead time or the turn-off dead time between the first control signal and the second control signal according to the voltage difference value, comprises:
calculating an opposite number of the voltage difference value;
calculating a product of the opposite number and a first coefficient to obtain an expected turn-on dead time; and/or, calculating a product of the opposite number and a second coefficient to obtain an expected turn-off dead time; and
modulating the second control signal according to at least one of the expected turn-on dead time and the expected turn-off dead time to adjust at least one of the turn-on dead time or the turn-off dead time between the first control signal and the second control signal.

7. The method according to claim 2, wherein adjusting at least one of the turn-on dead time or the turn-off dead time between the first control signal and the second control signal according to the voltage difference value, comprises:
calculating an opposite number of the voltage difference value;
calculating a product of the opposite number and a first coefficient to obtain an expected turn-on dead time; and/or, calculating a product of the opposite number and a second coefficient to obtain an expected turn-off dead time; and
modulating the second control signal according to at least one of the expected turn-on dead time and the expected turn-off dead time to adjust at least one of the turn-on dead time or the turn-off dead time between the first control signal and the second control signal.

8. The method according to claim 1, further comprising:
adjusting a switching frequency of the primary side switch and a switching frequency of the rectification switch according to the voltage difference value, to adjust the output voltage.

9. A resonant converter, comprising:
a switching circuit, wherein the switching circuit comprises a primary side switch controlled by a first control signal;
a resonant tank;
a transformer;
a synchronous rectification unit, wherein the synchronous rectification unit comprises a rectification switch controlled by a second control signal; and
a control unit, configured to calculate a voltage difference value obtained by subtracting a voltage value of an output voltage of the resonant converter from a reference voltage value, and adjust at least one of a turn-on dead time or a turn-off dead time between the first control signal and the second control signal according to the voltage difference value.

10. The resonant converter according to claim 9, wherein the control unit is configured to adjust at least one of the turn-on dead time or the turn-off dead time between the first control signal and the second control signal in response to that the voltage difference value is less than a first voltage threshold, wherein the first voltage threshold is less than or equal to 0V.

11. The resonant converter according to claim 10, wherein the at least one of the turn-on dead time or the turn-off dead time between the first control signal and the second control signal is adjusted to be increased with an increase in an opposite number of the voltage difference value.

12. The resonant converter according to claim 10, wherein the control unit is configured to maintain a duration of at least one of the turn-on dead time or the turn-off dead time as a target duration in response to that the voltage difference value is less than a second voltage threshold, wherein the target duration is a duration of at least one of the turn-on dead time or the turn-off dead time when the voltage difference value is equal to the second voltage threshold, wherein the second voltage threshold is less than the first voltage threshold, and in response to that the voltage difference value is less than the second voltage threshold, the rectification switch remains in an off state.

13. The resonant converter according to claim 12, wherein the control unit comprises:
a comparison unit, configured to calculate the voltage difference value obtained by subtracting the voltage value of the output voltage of the resonant converter from the reference voltage value;
an inversion unit, configured to calculate an opposite number of the voltage difference value in response to that the voltage difference value is less than a first voltage threshold, wherein the first voltage threshold is less than or equal to 0V;
a dead time controller, configured to generate at least one of an expected turn-on dead time or an expected turn-off dead time corresponding to the opposite number; and
a pulse width modulation generator, configured to modulate the second control signal according to at least one of the expected turn-on dead time or the expected turn-off dead time, to adjust at least one of the turn-on dead time or the turn-off dead time between the first control signal and the second control signal.

14. The resonant converter according to claim 13, wherein the control unit further comprises:
a dead time maintainer, configured to maintain at least one of the turn-on dead time or the turn-off dead time as a target duration in response to that the voltage difference value is less than the second voltage threshold, wherein the target duration is a duration of at least one of the turn-on dead time or the turn-off dead time when the voltage difference value is equal to the second voltage threshold and the second voltage threshold is less than the first voltage threshold.

15. The resonant converter according to claim 13, wherein the control unit is further configured to adjust a frequency of the first control signal and a frequency of the second control signal according to the voltage difference value, to adjust a switching frequency of the primary side switch and a switching frequency of the rectification switch.

16. The resonant converter according to claim 13, wherein the control unit further comprises:
a frequency controller, configured to generate an instruction for controlling the frequency of the first control signal and the frequency of the second control signal according to the voltage difference value;
wherein the pulse width modulation generator is further configured to adjust the frequency of the first control signal and the frequency of the second control signal according to the instruction.

17. The resonant converter according to claim 10, wherein the second voltage threshold is determined based on a rated voltage of a load carried by the resonant converter.

18. The resonant converter according to claim 9, wherein the dead time controller is configured to calculate a product of the opposite number and a first coefficient to obtain an expected turn-on dead time;
and/or,
calculate a product of the opposite number and a second coefficient to obtain an expected turn-off dead time.
